(19) United States
(12) Patent Application Publication
(10) Pub. No.: US 2024/0354362 A1
(43) Pub. Date: Oct. 24, 2024

(54) CONTINUOUS-VARIABLE QUANTUM COMPUTING SYSTEM AND METHODS FOR USE THEREWITH

(71) Applicant: BEIT Sp. z o.o., Kraków (PL)

(72) Inventors: Konrad Deka, Krakow (PL); Jan Marian Gwinner, Krakow (PL); Emil Zak, Krakow (PL)

(73) Assignee: BEIT Sp. z o.o., Kraków (PL)

(21) Appl. No.: 18/490,086

(22) Filed: Oct. 19, 2023

Related U.S. Application Data
(60) Provisional application No. 63/383,947, filed on Nov. 16, 2022.
(60) Provisional application No. 63/383,953, filed on Nov. 16, 2022.

(51) Int. Cl. G06F 17/11

(52) U.S. Cl. CPC G06F 17/11

(57) ABSTRACT

A continuous-variable quantum computing system includes: a quantum quadratic solution engine configured to generate a plurality of continuous-variable quantum results corresponding to each quadratic expression of a plurality of quadratic expressions; and a classical processor configured to: determine a set of weighting coefficients corresponding to a weighted sum of the plurality of quadratic expressions; and generate an output based on the set of weighting coefficients and the plurality of continuous-variable quantum results.

### CROSS-REFERENCE TO RELATED APPLICATIONS

The present U.S. Utility Patent application claims priority pursuant to 35 U.S.C. § 119 (e) to U.S. Provisional Application No. 63/383,947, entitled “CONTINUOUS-VARIABLE QUANTUM COMPUTING SYSTEM WITH GAUSSIAN BOSON SAMPLING AND METHODS FOR USE THEREWITH”, filed Nov. 16, 2022; and U.S. Provisional Application No. 63/383,953, entitled “CONTINUOUS-VARIABLE QUANTUM COMPUTING SYSTEM AND METHODS FOR USE THEREWITH”, filed Nov. 16, 2022, both of which are hereby incorporated herein by reference in their entirety and made part of the present U.S. Utility Patent Application for all purposes.

### BACKGROUND OF THE INVENTION

### Technical Field of the Invention

This invention relates generally to computer systems and particularly to quantum computing techniques and circuits.

### Description of Related Art

Computing devices are known to communicate data, process data, and/or store data. Such computing devices range from wireless smartphones, laptops, tablets, personal computers (PC), work stations, smart watches, connected cars, and video game devices, to web servers and data centers that support millions of web searches, web applications, or on-line purchases every day. In general, a computing device includes a processor, a memory system, user input/output interfaces, peripheral device interfaces, and an interconnecting bus structure.

Classical digital computing devices operate based on data encoded into binary digits (bits), each of which has one of the two definite binary states (i.e., 0 or 1). In contrast, most quantum computers utilize quantum-mechanical phenomena to encode data as quantum bits or qubits, which can be in superpositions of the traditional binary states.

### BRIEF DESCRIPTION OF THE SEVERAL VIEWS OF THE DRAWING(S)

FIG. 1A is a schematic block diagram of an example continuous-variable quantum computing system.

FIG. 1B is a flow diagram of an example method.

FIG. 2A is a schematic block diagram of an example continuous-variable quantum computing system.

FIG. 2B is a flow diagram of an example method.

### DETAILED DESCRIPTION

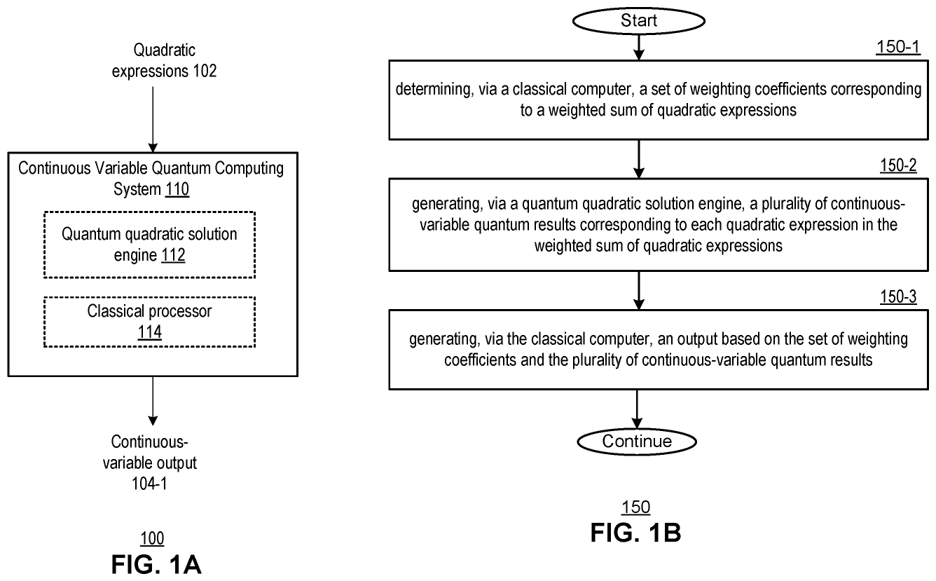

FIG. 1A is a schematic block diagram 100 of an example continuous-variable quantum computing system. In particular, a continuous-variable quantum computing system 110 is presented that includes a quantum quadratic solution engine 112 and a classical processor 114. Unlike traditional quantum computing systems that operate on qubits in finite Hilbert spaces that yield measurements that are digital, the continuous-variable quantum computing system 110 operates in the quantum realm via numerical values belonging to continuous intervals, making the quantum portions of this system more akin to continuous-variable, i.e., “analog” systems. These quantum systems can, for example, provide exponential speed-up when compared with classical computing systems.

The classical processor 114 can be implemented via one or more processing circuits or other processing device(s). Each such processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. Each such processing device can operate in conjunction with an attached memory and/or an integrated memory element such as classical memory or other memory device, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information.

Note that if the classical processor 114 is implemented via more than one processing device, the processing devices may be centrally located (e.g., directly coupled together via a wired and/or wireless bus structure) or may be distributedly located (e.g., cloud computing via indirect coupling via a local area network and/or a wide area network). Further note that if the classical processor 114 implements one or more of its gates or other functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, a memory can store, and a processing device can execute, hard coded and/or other operational instructions corresponding to at least some of the steps and/or functions illustrated in one or more of the Figures. Such a memory device or memory element can be tangible memory device or other non-transitory storage medium included in or implemented as an article of manufacture.

In various examples, the quantum quadratic solution engine 112 of the continuous-variable quantum computing system 110 includes a Gaussian boson sampler, boson sampler, a linear optical quantum computing system or other optical quantum computer and/or other optical quantum computer that makes use of physical observables, such as photons, other optical signals and/or other electromagnetic signals to operate on continuous-variable quantum modes and/or other quantum computing systems to generate solutions to quantum quadratic expressions such as exponential functions of quadratic polynomials, quadratic non-linear systems of equations (QNSE), post-quantum solutions to Boolean multivariate quadratic equations, etc.

Consider the Gaussian boson sampler as an example. The capabilities of a gaussian boson sampler can be described as follows: first, quantum modes are all initialized in a vacuum state |0>. Next, several Gaussian operations are applied to the modes. Finally, a photon-counting measurement is applied to the modes, producing for each mode an integer-photon count, greater or equal to zero. The results of these k measurements can be stored as a sequence m=(m_1, . . . m_k).

The operation of a gaussian boson sampler is probabilistic in nature. The probability of obtaining the result m is equal to |<m|V|0>|\hat{ }2. Here, V is a unitary operator describing the Gaussian operations performed. Thus, by a repeated usage of a Gaussian boson sampler, one can approximately discover the quantity |<m|V|0>|\hat{ }2. Quantities of interest can often be written as |<m|Uf|0>|\hat{ }2, where U is a unitary operator/transformation on some sequence of Gaussian operations and f is a polynomial expression of position operators q_1, . . . q_k on each mode.

Many problems in science and mathematics are formulated as quadratic expressions that are based on second-order polynomials (i.e., order=2). Examples include the linear quadratic regulator used in optimal control theory, trajectories of objects in free-fall, Witt groups (fields or rings) in mathematics, planetary dynamics in astronomy, the design of arches in architecture, etc. In spite of the fact that many real-world systems are more complex and for example, include non-linearities and/or higher-order terms, second-order formulations are used nevertheless to facilitate easier solutions. The continuous-variable quantum computing system 110 improves the technology of quantum computing systems by leveraging quantum results generated by a quantum quadratic solution engine 112 to generate more accurate continuous-value output of higher than quadratic order (e.g., order of 3 or higher).

In various examples of the continuous-variable quantum computing system 110, the quantum quadratic solution engine 112 is configured to generate a plurality of continuous-variable quantum results corresponding to each quadratic expression of a plurality of quadratic expressions 102. The classical processor 114 is configured to: determine a set of weighting coefficients corresponding to a weighted sum of the plurality of quadratic expressions; and to generate an output 104 based on the set of weighting coefficients and the plurality of continuous-variable quantum results.

In addition or in the alternative to the foregoing, the quantum quadratic solution engine includes a Gaussian boson sampler.

In addition or in the alternative to the foregoing, the Gaussian boson sampler applies a photon-counting measurement to generate an integer photon count for each of a plurality of quantum modes.

In addition or in the alternative to the foregoing, the set of weighting coefficients is determined based on a Taylor series expansion of the weighted sum of quadratic expressions.

In addition or in the alternative to the foregoing, the set of weighting coefficients is determined utilizing linear programming.

In addition or in the alternative to the foregoing, the set of weighting coefficients is determined utilizing least-squares optimization.

In addition or in the alternative to the foregoing, the output is determined by the product of a unitary transformation and a polynomial expression of order greater than 2.

In addition or in the alternative to the foregoing, each term of the weighted sum is a probability of obtaining certain measurement in a circuit consisting of an exponential function of a quadratic expression, followed by a unitary transformation.

In addition or in the alternative to the foregoing, the corresponding quadratic expression is a quadratic expression of a plurality of position operators.

Consider the following example where expressions of the form |<m|U exp (p)|0>|\hat{ }2 can be computed via a quantum quadratic solution engine 112 such as a GBS, and where p is an at most quadratic expression of position operators q_1, . . . q_k. The continuous-variable quantum computing system 110 can calculate an approximation of |<m|Uf|0>|\hat{ }2 by:
Searching for an approximation of the form

$$\vert 〈 m \vert Uf \vert 0 〉 \vert \hat{} 2 = \sum a\_i \vert 〈 m \vert U exp ( p\_i ) \vert 0 〉 \vert \hat{} 2 , \qquad ( Eq . 1 )$$

where a_i are complex numbers, and p_i are at most quadratic expression of the position operators and f has an order greater than 2. This step can comprise:
   selecting a set of polynomials p_i,
   computing the Taylor series expansion of right-hand side of (Eq. 1),
   finding suitable coefficients a_i, via a curve fitting technique such as the least-squares optimization or a method of linear programming.

The approximation produced is such that the Taylor series expansions of both sides of the (Eq. 1) agree up to a certain degree—within a certain threshold. In various examples, the set of polynomials can be adjusted iteratively until the Taylor series expansions of both sides of (Eq. 1) agree up within a predetermined accuracy threshold.
The value of |<m|Uf|0>|\hat{ }2 can then be computed by generating quantum results for each of the quadratic expressions |<m|U exp(p_i)|0>|\hat{ }2 via quantum quadratic solution engine 112 and then by computing the weighted sum of these results via the classical processor 114.

It should be noted that while the example above presents quadratic expressions of the form |<m|U exp(p_i)|0>|\hat{ }2, other functions of quadratic polynomials that are solvable by via a quantum quadratic solution engine 112 can likewise be utilized in weighted sums to approximate the higher order result |<m|Uf|0>|\hat{ }2. Further discussion regarding the operation of continuous-variable quantum computing system 110, including several optional functions and features are described in conjunction with the figures that follow.

FIG. 1B is a flow diagram 150 of an example method. In particular, a method is presented for use with one or more functions and features described in conjunctions with FIG. 1A. Step 150-1 includes determining, via a classical computer, a set of weighting coefficients corresponding to a weighted sum of quadratic expressions. Step 150-2 includes generating, via a quantum quadratic solution engine, a plurality of continuous-variable quantum results corresponding to each quadratic expression in the weighted sum of quadratic expressions. Step 150-03 includes generating, via the classical computer, an output based on the set of weighting coefficients and the plurality of continuous-variable quantum results.

In addition or in the alternative to the foregoing, the quantum quadratic solution engine includes a Gaussian boson sampler.

In addition or in the alternative to the foregoing, the Gaussian boson sampler applies a photon-counting measurement to generate an integer photon count for each of a plurality of quantum modes.

In addition or in the alternative to the foregoing, the set of weighting coefficients is determined based on a Taylor series expansion of the weighted sum of quadratic expressions.

In addition or in the alternative to the foregoing, the set of weighting coefficients is determined utilizing linear programming.

In addition or in the alternative to the foregoing, the set of weighting coefficients is determined utilizing least-squares optimization.

In addition or in the alternative to the foregoing, the output is determined by the product of a unitary transformation and a polynomial expression of order greater than 2.

In addition or in the alternative to the foregoing, each term of the weighted sum is a probability of obtaining certain measurement in a circuit consisting of an exponential function of a quadratic expression, followed by a unitary transformation.

In addition or in the alternative to the foregoing, the corresponding quadratic equation is a quadratic equation of a plurality of position operators.

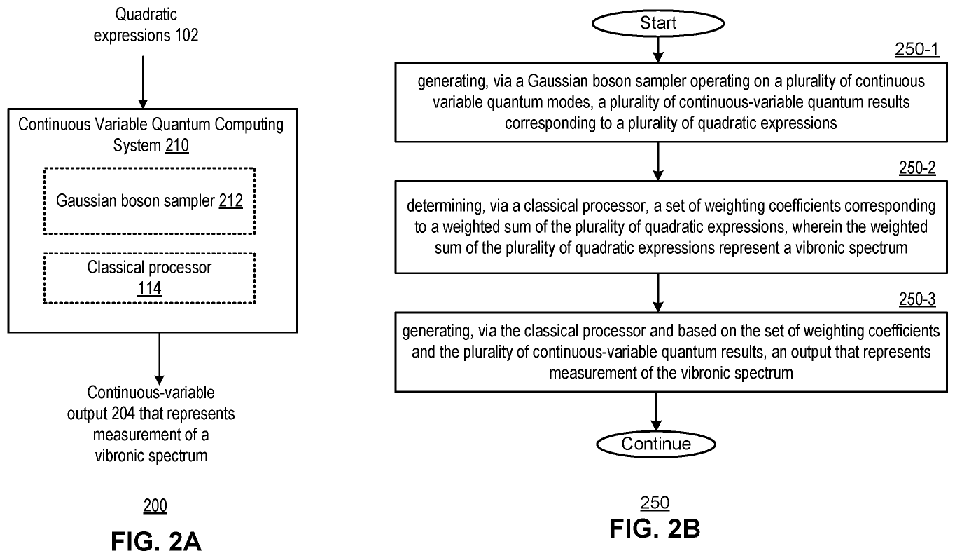

FIG. 2A is a schematic block diagram 200 of an example continuous-variable quantum computing system. In particular, a continuous-variable quantum computing system 210, that can operate similarly to continuous-variable quantum computing system 110 but that implements the quantum quadratic solution engine 112 as a Gaussian boson sampler 212. Furthermore, the continuous-variable quantum computing system 210 generates an output straightforwardly convertible to the vibronic spectrum.

Calculating the vibrational-electronic (vibronic) spectra of molecules is a problem of prime importance to a number of areas of science and industry. Vibronic spectra have found applications in, for example, remote sensing, studies of exoplanetary atmospheres, photo-chemistry, prediction of radiation damage mechanisms and the simulations of quantum yields in photovoltaic devices.

The vibronic spectrum is a collection of transitions and their probabilities and is something that any molecule possesses. Physical parameters of the molecule, which can be either measured or calculated, serve to compute the Herzberg-Teller expansion in the form of a polynomial f. The rotation of the molecule's normal coordinates upon vibronic excitation is accounted for by the unitary Doktorov transformation U. The computation of the vibronic spectrum can be accomplished by computing the quantity |<m|Uf|0>|\hat{ }2 for several values of m, determined by the frequency range for the spectrum. In this case, Uff0> is the result of applying, to state |0>, first to the polynomial f, and then the unitary operator U. The computational task of calculating general vibronic spectra has been found to belong to the #P complexity class, i.e. hard to simulate on a classical computer. Due to this fact, the possibility of obtaining precise numerical results with a purely classical computer is highly limited.

In various examples of the continuous-variable quantum computing system 110, the Gaussian boson sampler 212 operates on a plurality of continuous variable quantum modes and is configured to generate a plurality of continuous-variable quantum results corresponding to a plurality of quadratic expressions. The classical processor 114 is configured to: determine a set of weighting coefficients corresponding to a weighted sum of the plurality of quadratic expressions, wherein the weighted sum of the plurality of quadratic expressions represent a vibronic spectrum; and to generate, based on the set of weighting coefficients and the plurality of continuous-variable quantum results, an output that represents measurement of the vibronic spectrum.

In addition or in the alternative to the foregoing, the Gaussian boson sampler applies a photon-counting measurement to generate an integer photon count for each of a plurality of quantum modes.

In addition or in the alternative to the foregoing, the set of weighting coefficients is determined based on a Taylor series expansion of the weighted sum of quadratic expressions.

In addition or in the alternative to the foregoing, the set of weighting coefficients is determined utilizing linear programming.

In addition or in the alternative to the foregoing, the set of weighting coefficients is determined utilizing least-squares optimization.

In addition or in the alternative to the foregoing, the continuous-variable output corresponds to a Doktorov transformation of a polynomial expression of order greater than 2.

In addition or in the alternative to the foregoing, each quadratic expression of the plurality of quadratic expressions is a Doktorov transformation of an exponential function of a corresponding quadratic equation.

In addition or in the alternative to the foregoing, the corresponding quadratic equation is a quadratic equation of a plurality of position operators.

Consider the following example where the Gaussian boson sampler (GBS) 212 calculates vibronic spectra as follows.

### Quadratic Technique

Assume that f contains terms of degree at most 2,
Note that the quantity g(t)=|<m|U exp(tf)|0>|\hat{ }2, where t is any complex number, can be obtained using a GBS and in this case, the unitary transformation U is the Doktorov transformation. This step requires a GBS circuit, and relies on f having terms of degree at most 2 (i.e, f is a quadratic equation),
Then, the vibronic spectra quantity can be approximated as follows:
   |<m|Uf|0>|\hat{ }2≈(g(it)+0.5g(t)+0.5g(−t)−2g(0))/2t\hat{ }2, where t is a small real number.
Thus, one could employ the GBS to calculate the quantities g(it), g(t), g(−t), g(0), and then calculate the quantity of interest using the formula above.

While this provides a useful approximation of a vibronic spectrum using a GBS, this Quadratic Technique is limited by its quadratic assumption and necessarily ignores any higher-order terms (third-order or higher). In various examples of the continuous-variable quantum computing system 110, the classical computer 114 interacts with the GBS 212 to leverage the Quadratic Technique to accommodate such higher-order models.

In accordance with this example, the continuous-variable quantum computing system 110 allows for terms of any degree expressing f (e.g., order three or greater) and operates as follows:
Consider expressions of the form |<m|U exp(p)|0>|\hat{ }2, where p is an at most quadratic expression of position operators q_1, . . . q_k. As described in the Quadratic Technique above, such quantity can be obtained using the GBS 212.
Again, search for an approximation of the form of Eq. 1

$$\vert 〈 m \vert Uf \vert 0 〉 \vert \hat{} 2 = \sum a\_i \vert 〈 m \vert U exp ( p\_i ) \vert 0 〉 \vert \hat{} 2 ,$$

where a_i are complex numbers, and p_i are at most quadratic expression of the position operators. This step can comprise:
   selecting a set of polynomials p_i,
   computing the Taylor series expansion of right-hand side of (Eq. 1),
   finding suitable coefficients a_i, via a curve fitting technique such as the least-squares optimization or a method of linear programming.

The approximation produced is such that the Taylor series expansions of both sides of the (Eq. 1) agree up to a certain degree-within a certain threshold. In various examples, the set of polynomials can be adjusted iteratively until the Taylor series expansions of both sides of (Eq. 1) agree up within a predetermined accuracy threshold.
The value of |<m|Uf|0>|\hat{ }2 can then be computed via GBS 212 using the Quadratic Technique to calculate the results for each quadratic expressions |<m|U exp(p_i)|0>|\hat{ }2 and then by computing the weighted sum of these results.

This solution takes into consideration higher order terms that can improve the accuracy of the solution.

FIG. 2B is a flow diagram 250 of an example method. In particular, a method is presented for use with one or more functions and features described in conjunctions with FIG. 1A, 1B and/or 2A. Step 250-1 includes generating, via a Gaussian boson sampler operating on a plurality of continuous variable quantum modes, a plurality of continuous-variable quantum results corresponding to a plurality of quadratic expressions. Step 250-2 includes determining, via a classical processor, a set of weighting coefficients corresponding to a weighted sum of the plurality of quadratic expressions, wherein the weighted sum of the plurality of quadratic expressions represent a vibronic spectrum; and Step 250-3 includes generating, via the classical processor and based on the set of weighting coefficients and the plurality of continuous-variable quantum results, an output that represents measurement of the vibronic spectrum.

In addition or in the alternative to the foregoing, the Gaussian boson sampler applies a photon-counting measurement to generate an integer photon count for each of a plurality of quantum modes.

In addition or in the alternative to the foregoing, the set of weighting coefficients is determined based on a Taylor series expansion of the weighted sum of quadratic expressions.

In addition or in the alternative to the foregoing, the set of weighting coefficients is determined utilizing linear programming.

In addition or in the alternative to the foregoing, the set of weighting coefficients is determined utilizing least-squares optimization.

In addition or in the alternative to the foregoing, the continuous-variable output corresponds to a Doktorov transformation of a polynomial expression of order greater than 2.

In addition or in the alternative to the foregoing, each quadratic expression of the plurality of quadratic expressions is a Doktorov transformation of an exponential function of a corresponding quadratic equation.

In addition or in the alternative to the foregoing, the corresponding quadratic equation is a quadratic equation of a plurality of position operators.

### I. Further Example

Consider the following further example that includes functions and features that can be used in addition to or in the alternative of any of the foregoing continuous-variable quantum computing systems and methods. The variables, α, α^{\} are the annihilation and creation operators. Define q=(α+α^{\})·2^{-0.5}. In dealing with circuits acting on n modes, qⱼ is used to denote an operator acting on j-th mode, for j=1 . . . n. Consider an arbitrary operator T quadratic in operators q₁ . . . qₙ that is, an operator that can be written as

$$T = {c}_{0} + {Σ}_{i = 1}^{n} {c}_{1}^{i} {q}_{i} + {Σ}_{i , j = 1}^{n} {c}_{2}^{i j} {q}_{i} {q}_{j} , \qquad ( 1 )$$

where c₀, c₁ⁱ, c₂^{ij} are arbitrary complex numbers. For a suitable quantum photonic circuit P containing only Gaussian operations, and a scaling factor c_{T}∈∈ [symbol] (dependent on T), consider

$$exp ( T ) \vert 0 … 0 〉 = {c}_{T} P \vert 0 … 0 〉 . \qquad ( 2 )$$

Sections II and III below describe examples of how to produce a circuit P for a given T. Section IV explains how this can be leveraged to compute quantities of type |<m|Uf|0>|², where U is another photonic quantum circuit and f is a polynomial expression of q₁ . . . qₙ. These techniques improve the calculations of vibronic spectra and can be applied to other continuous-variable quantum computing systems and methods.

### II. Single Mode

Consider an expression exp (α₁q+α₂q²)|0> for α₁∈ [symbol] , α₂∈ [symbol] . Note that equation (16) of Jnane et al., Analog Quantum Simulation of Non-Condon Effects in Molecular Spectroscopy, (2021). (the Jnane paper”), uses this expression (under the substitution Kbⱼ, Kdⱼ=α₁, α₂). The formula given in the Jnane paper, however, appears incorrect. Taking a look at supplementary information of the Jnane paper, we follow their reasoning up to second equality of equation (11), which states

$$exp ( {a}_{1} q + {a}_{2} {q}^{2} ) \vert 0 〉 = \frac{1}{\sqrt{\vert s \vert ( 1 - {a}_{2} )}} exp ( {a}_{1} q ) S ( - ξ ) \vert 0 〉 \qquad ( 3 )$$

where

$$t = \frac{{a}_{2}}{1 - {a}_{2}} ,$$

r=|t|, θ=arg(t), ξ=arctanh(r) exp(iθ), s=sech(|ξ|), and S stands for the squeezing operator. Consequently, this example follows the Strawberryfields definition of the squeezing operator, i.e.

$$S ( z ) = exp ( \frac{( {z}^{*} {a}^{2} - {za}^{†2} )}{2} ) ,$$

which differs from the Jnane paper by the minus sign). From this point, the computation of the Jnane paper makes a further error. Specifically, the simplified Baker-Hausdorff-Campbell formula

$$exp ( A + B ) = exp ( A ) exp ( B ) exp ( - \frac{1}{2} [ A , B ] )$$

used therein holds only if [A, B] commutes with both A, B, which is not the case here. For this reason, this example uses the relations

$${S}^{†} ( z ) aS ( z ) = a cosh ( \vert z \vert ) - {a}^{†} \frac{z}{\vert z \vert} sinh ( \vert z \vert ) ,$$

(also know as a “squeeze operator”). Taking adjoint of both sides, adding up the equations, and substituting z=—ξ, yields

$${S}^{†} ( - ξ ) qS ( - ξ ) = {β}^{*} a + β {a}^{†} ,$$

where

$$β = \frac{1}{\sqrt{2}} ( cosh ( {r}_{2} ) - {e}^{i {θ}_{2}} sinh ( {r}_{2} ) ) , {r}_{2} = \vert ξ \vert , {θ}_{2} = arg ( - ξ ) .$$

Continuing the computation in (3), obtains:

$$exp ( {a}_{1} q ) S ( - ξ ) \vert 0 〉 = exp ( {\vert β \vert}^{2} {a}_{1} ℜ {a}_{1} ) S ( - ξ ) D ( {a}_{1} β ) \vert 0 〉 \qquad ( 4 )$$

which constitutes the correct expression, together with the constant from equation (3).

### III. Dealing with Multimode Quadratic Expressions

Consider a photonic quantum circuit P that does the job described in equation (2).
Without loss of generality, we can assume that the matrix [c₂^{ij}]_{j=1 . . . n}^{i=1 . . . n} is a symmetric matrix (with complex entries), since q₁ . . . qₙ all commute.
Diagonalize its real and imaginary parts separately:

$$ℜ {c}_{2} = {UDU}^{†} and 𝔍 {c}_{2} = {U}_{im} {D}_{im} {U}_{im}^{†} .$$

Implement the (exponent of the) imaginary part. This is done as follows:

$$exp ( {\sum }_{i , j = 1}^{n} 𝔍 {c}_{2}^{ij} {q}_{i} {q}_{j} ) = {U}_{im} {\prod }_{j = 1}^{n} exp ( {iD}_{im}^{jj} {q}_{j}^{2} ) {U}_{im}^{†} \qquad ( 5 )$$

where Dᵢₘ^{jj} is the j-th diagonal entry of matrix Dᵢₘ. Recall that the P-gate is Gaussian and defined as

$$P ( s ) = exp ( \frac{{isq}^{2}}{2} )$$

which is the expression in the product in (5). The unitaries Uᵢₘ, Uᵢₘ^{\} are generalized interferometers, and so they can be implemented using a suitable combination of rotation gates and standard, two-mode interferometers.
Implement the (exponent of the) remaining parts of (1). That is, we need to implement

$$exp ( {\sum }_{j = 1}^{n} {c}_{1}^{j} {q}_{j} + {\sum }_{i , j = 1}^{n} ℜ {c}_{2}^{ij} {q}_{i} {q}_{j} ) = U ( {\prod }_{j = 1}^{n} exp ( {C}_{1}^{j} {q}_{j} + {D}_{jj} {q}_{j}^{2} ) ) {U}^{†} \qquad ( 6 )$$

where C₁=Uc₁. Again, U, U^{\} are generalized generalized interferometers, so they can be decomposed into basic optical gates. For the inner part of the sum (6), formulas (3) and (4) can be combined. Together, these express the necessary operators in terms of the squeezing gate S and the displacement gate D, which are again basic optical gates. The constant c_{T} of equation (1) is computable (by keeping track of multiplicative constants in steps above).

### IV. Obtaining Higher-Order Expressions Via Linear Combinations

Use 0̅=(0 . . . 0) to denote the sequence of n zeros. As seen above, for any expression T at most quadratic in q₁ . . . qₙ we can find a photonic quantum circuit P such that exp(T)|0 [symbol] =cP|0 [symbol] . Let U be another photonic quantum circuit (one useful goal would be to set U=Doktorov transformation, but the method described does not rely on any specific property of U). If we perform the circuit P, then U, and then a photon-counting measurement on each of the modes, we will observe the integers m̅=m₁ . . . mₙ as a result with probability |c_{T}⁻¹<m̅|U exp(T)|0̅>|². This quantity can be determined by repeating the experiment, observing the frequency of the event of measuring m̅, and dividing by the constant |C_{T}⁻²|.

Suppose that f is a polynomial in variables q₁ . . . qₙ, and it is desired to compute the quantity |<m̅|Uf|0̅>|². The technique can search for an approximate equality of the form

$${\vert 〈 \overline{m} \vert Uf \vert \overline{0} 〉 \vert}^{2} \approx {\sum }_{i = 1}^{N} {a}_{i} {\vert 〈 \overline{m} \vert U exp ( {T}_{i} ) \vert \overline{0} 〉 \vert}^{2} \qquad ( 7 )$$

where αᵢ are complex numbers, and Tᵢ are at most quadratic in q₁ . . . qₙ. If we are successful, again by repeated experiments the quantity on the right side can be measured.

Suppose that Tᵢ are explicitly given, for now. For an n-tuple of integers l=i₁ . . . iₙ, define qₗ=q₁ⁱ^{₁} . . . qₙⁱ^{ₙ} and sₗ=<m̅|Uqₗ|0̅>. In vibronics, sₗ is a real number. We can write f=Σ fₗ qₗ, and insert this sum into the left side of equation (7). On the right side, we expand the exponents using Taylor expansion truncated at some chosen degree D. The equation (7) then becomes

$${\sum }_{\dot{I} , J} {f}_{I} \overline{{f}_{J}} {s}_{I} {s}_{J} = {\sum }_{i = 1}^{N} {a}_{i} ( {\sum }_{\dot{I} , J} {T}_{iI} \overline{{T}_{iJ}} {s}_{I} {s}_{J} ) \qquad ( 8 )$$

where Tᵢₗ are the coefficients resulting from the Taylor expansions. The summation goes over all I, J with the total degree less or equal to D. Regrouping the terms, we have

$${\sum }_{\dot{I} , J} {f}_{I} \overline{{f}_{J}} {s}_{I} {s}_{J} = {\sum }_{\dot{I} , J} {s}_{I} {s}_{J} ( {\sum }_{i = 1}^{N} {a}_{i} {T}_{iI} \overline{{T}_{iJ}} ) \qquad ( 9 )$$

Treating αᵢ as unknowns, we would like to have

$${f}_{I} \overline{{f}_{J}} = {\sum }_{i = 1}^{N} {a}_{i} {T}_{iI} \overline{{T}_{iJ}} \qquad ( 10 )$$

for all I, J. Equation (10) is a linear system of equations. As long as N is greater than the number of constraints, suitable numbers aᵢ can be computed, and equation (7) will be satisfied (subject to an error incurred from truncating the Taylor series).

### V. Considerations

When computing |<m̅|Uf|0̅>|² by the means of equation (7), the achievable accuracy should be considered. Since the right-hand side of equation (7) is measured experimentally, the number of samples that can be realistically gathered is large, but limited (for example, the GBS machine of Xanadu produces roughly a hundred thousand samples per second; see “Quantum computational advantage with a programmable photonic processor”, Madsen et al. 2022). So the measurement is effectively a random variable with some variance; the smaller the variance, the larger the accuracy of our computation (assuming a fixed number of samples). To make the whole computation manageable, one can select the number of right-hand-side terms N, the degree D at which the Taylor series is truncated, and the quadratic polynomials Tᵢ. Consider several guidelines for selecting the proper parameters:
The solution of equations (10) could be chosen to minimize the L² norm \sqrt{Σᵢ|αᵢ|²}. The step of solving the linear system should then be replaced with a least squares optimization step.
The solution of equations (10) could be chosen to minimize the L¹ norm Σ|αᵢ|. The step of solving the linear system should then be replaced with a suitable linear optimization program.
In general, the larger the number N of the right-hand-side terms, the lower norms should be achievable in these optimization steps. On the other hand, the larger N is, the more variables the system of equations (10) contains.
The larger the degree D), the smaller the error incurred by the Taylor series truncation. On the other hand, as D grows, the number of equations of system (10) grows.
The polynomials Tᵢ can be chosen in several ways. One can choose their coefficients randomly, or choose the coefficients covering a grid.

It is noted that terminologies as may be used herein such as bit stream, stream, signal sequence, etc. (or their equivalents) have been used interchangeably to describe digital information whose content corresponds to any of a number of desired types (e.g., data, video, speech, text, graphics, audio, etc. any of which may generally be referred to as ‘data’).

As may be used herein, the terms “substantially” and “approximately” provide an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in a form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., data is retained when power is removed from the memory element). As used herein, a transitory medium shall mean one or more of: (a) a wired or wireless medium for the transportation of data as a signal from one computing device to another computing device for temporary storage or persistent storage; (b) a wired or wireless medium for the transportation of data as a signal within a computing device from one element of the computing device to another element of the computing device for temporary storage or persistent storage; (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium.

One or more functions associated with the methods and/or processes described herein can be implemented via a processing module that operates via the non-human “artificial” intelligence (AI) of a machine. Examples of such AI include machines that operate via anomaly detection techniques, decision trees, association rules, expert systems and other knowledge-based systems, computer vision models, artificial neural networks, convolutional neural networks, support vector machines (SVMs), Bayesian networks, genetic algorithms, feature learning, sparse dictionary learning, preference learning, deep learning and other machine learning techniques that are trained using training data via unsupervised, semi-supervised, supervised and/or reinforcement learning, and/or other AI. The human mind is not equipped to perform such AI techniques, not only due to the complexity of these techniques, but also due to the fact that artificial intelligence, by its very definition-requires “artificial” intelligence—i.e. machine/non-human intelligence.

One or more functions associated with the methods and/or processes described herein can be implemented as a large-scale system that is operable to receive, transmit and/or process data on a large-scale. As used herein, a large-scale refers to a large number of data, such as one or more kilobytes, megabytes, gigabytes, terabytes or more of data that are received, transmitted and/or processed. Such receiving, transmitting and/or processing of data cannot practically be performed by the human mind on a large-scale within a reasonable period of time, such as within a second, a millisecond, microsecond, a real-time basis or other high speed required by the machines that generate the data, receive the data, convey the data, store the data and/or use the data.

One or more functions associated with the methods and/or processes described herein can require data to be manipulated in different ways within overlapping time spans. The human mind is not equipped to perform such different data manipulations independently, contemporaneously, in parallel, and/or on a coordinated basis within a reasonable period of time, such as within a second, a millisecond, microsecond, a real-time basis or other high speed required by the machines that generate the data, receive the data, convey the data, store the data and/or use the data.

One or more functions associated with the methods and/or processes described herein can be implemented in a system that is operable to electronically receive digital data via a wired or wireless communication network and/or to electronically transmit digital data via a wired or wireless communication network. Such receiving and transmitting cannot practically be performed by the human mind because the human mind is not equipped to electronically transmit or receive digital data, let alone to transmit and receive digital data via a wired or wireless communication network.

One or more functions associated with the methods and/or processes described herein can be implemented in a system that is operable to electronically store digital data in a memory device. Such storage cannot practically be performed by the human mind because the human mind is not equipped to electronically store digital data.

One or more functions associated with the methods and/or processes described herein may operate to cause an action by a processing module directly in response to a triggering event—without any intervening human interaction between the triggering event and the action. Any such actions may be identified as being performed “automatically”, “automatically based on” and/or “automatically in response to” such a triggering event. Furthermore, any such actions identified in such a fashion specifically preclude the operation of human activity with respect to these actions—even if the triggering event itself may be causally connected to a human activity of some kind.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A continuous-variable quantum computing system comprising:
a quantum quadratic solution engine configured to generate a plurality of continuous-variable quantum results corresponding to each quadratic expression of a plurality of quadratic expressions; and
a classical processor configured to:
determine a set of weighting coefficients corresponding to a weighted sum of the plurality of quadratic expressions; and
generate an output based on the set of weighting coefficients and the plurality of continuous-variable quantum results.

2. The continuous-variable quantum computing system of claim 1, wherein the quantum quadratic solution engine includes a Gaussian boson sampler.

3. The continuous-variable quantum computing system of claim 2, wherein the Gaussian boson sampler applies a photon-counting measurement to generate an integer photon count for each of a plurality of quantum modes.

4. The continuous-variable quantum computing system of claim 1, wherein the set of weighting coefficients is determined based on a Taylor series expansion of the weighted sum of quadratic expressions.

5. The continuous-variable quantum computing system of claim 4, wherein the set of weighting coefficients is determined utilizing linear programming.

6. The continuous-variable quantum computing system of claim 4, wherein the set of weighting coefficients is determined utilizing least-squares optimization.

7. The continuous-variable quantum computing system of claim 4, wherein the set of weighting coefficients is determined utilizing curve-fitting.

8. The continuous-variable quantum computing system of claim 1, wherein the output is determined by a product of a unitary transformation and a polynomial expression of order greater than 2.

9. The continuous-variable quantum computing system of claim 1, wherein each term of the weighted sum is a probability of obtaining certain measurement in a circuit consisting of an exponential function of a quadratic expression, followed by a unitary transformation.

10. The continuous-variable quantum computing system of claim 8, wherein the corresponding quadratic expression is a quadratic expression of a plurality of position operators.

11. A method comprising:
determining, via a classical computer, a set of weighting coefficients corresponding to a weighted sum of quadratic expressions;
generating, via a quantum quadratic solution engine, a plurality of continuous-variable quantum results corresponding to each quadratic expression in the weighted sum of quadratic expressions; and
generating, via the classical computer, a continuous-variable output based on the set of weighting coefficients and the plurality of continuous-variable quantum results.

12. The method of claim 11, wherein the quantum quadratic solution engine includes a Gaussian boson sampler.

13. The method of claim 12, wherein the Gaussian boson sampler applies a photon-counting measurement to generate an integer photon count for each of a plurality of quantum modes.

14. The method of claim 11, wherein the set of weighting coefficients is determined based on a Taylor series expansion of the weighted sum of quadratic expressions.

15. The method of claim 14, wherein the set of weighting coefficients is determined utilizing linear programming.

16. The method of claim 14, wherein the set of weighting coefficients is determined utilizing least-squares optimization.

17. The method of claim 14, wherein the set of weighting coefficients is determined utilizing curve-fitting.

18. The method of claim 11, wherein the output is determined by a product of a unitary transformation and a polynomial expression of order greater than 2.

19. The method of claim 11, wherein each term of the weighted sum is a probability of obtaining certain measurement in a circuit consisting of an exponential function of a quadratic expression, followed by a unitary transformation.

20. The method of claim 19, wherein the corresponding quadratic expression is a quadratic expression of a plurality of position operators.
